(19) United States
(12) Patent Application Publication
(10) Pub. No.: US 2008/0185936 A1
(43) Pub. Date: Aug. 7, 2008

(54) Optically driven carbon nanotube actuators

(76) Inventors: Balaji Panchapakesan, Wilmington, DE (US); Shaoxin Lu, bloomfield, NJ (US)

Correspondence Address: RATNERPRESTIA, P.O. BOX 1596, WILMINGTON, DE, 19899, US

(21) Appl. No.: 11/900,185

(22) Filed: Sep. 10, 2007

Related U.S. Application Data
(60) Provisional application No. 60/843,727, filed on Sep. 11, 2006.

(51) Int. Cl. H02N 10/00; B29D 11/00

(52) U.S. Cl. 310/306; 216/24

(57) ABSTRACT

Methods for actuating, actuator devices and methods for preparing an actuator device capable of converting optical energy into mechanical energy are provided. An actuator includes a carbon nanotube film having a first optical absorption coefficient and an actuation material having a second optical absorption coefficient different from the first optical absorption coefficient. The actuator expands due to actuation by light. A carbon nanotube film is prepared by forming a carbon nanotube film on a substrate and forming a photoresist layer that exposes portions of the carbon nanotube film. The exposed portions are then etched to form an actuator device from the remaining carbon nanotube film.

### CROSS REFERENCE TO RELATED APPLICATIONS

This application is related to and claims the benefit of U.S. Provisional Application No. 60/843,727 entitled OPTICALLY DRIVEN CARBON NANOTUBE ACTUATORS filed on Sep. 11, 2006, the contents of which are incorporated herein by reference.

### REFERENCE TO U.S. GOVERNMENT SUPPORT

The present invention was supported in part by a grant from the National Science Foundation (Grant Number ECS0546328). The United States government has certain rights in the invention.

### FIELD OF THE INVENTION

The present invention relates to optically driven carbon nanotube actuators. More particularly, the present invention relates to carbon nanotube actuators and methods of forming carbon nanotube actuators that are mechanically activated upon exposure to a light source.

### BACKGROUND OF THE INVENTION

The direct conversion of non-mechanical energy, such as optical and electrical energy into mechanical energy, is of interest in various fields, e.g., robotics, artificial muscles, optical communication, micro-mechanical devices, etc. The direct conversion of electrical energy to mechanical energy has been demonstrated in a number of different technology arenas with materials such as piezoelectric ceramics, shape memory alloys, and magnetostrictive materials. Carbon nanotubes, metal nano-particles, and polymer actuators have also been proposed for converting electrical energy to mechanical energy. While the conversion of electrical energy to mechanical energy is relatively easy, the direct conversion of optical photon energy to mechanical energy is more difficult.

### SUMMARY OF THE INVENTION

According to one embodiment, the present invention relates to methods of actuation and actuation devices. A light source is activated to transmit light and an actuator is exposed to the transmitted light. The actuator includes a carbon nanotube sheet and an actuation material in communication with the carbon nanotube sheet. The carbon nanotube sheet has a first optical absorption coefficient and the actuation material has a second optical absorption coefficient different from the first optical absorption coefficient. The actuator expands when exposed to the transmitted light to mechanically actuate the actuator.

According to another embodiment, the present invention relates to methods of preparing a carbon nanotube actuator device. A carbon nanotube film is formed on a substrate. A photoresist layer is formed on the carbon nanotube film that exposes portions of the carbon nanotube film. The exposed portions of the carbon nanotube film are etched to form the actuator device from the remaining carbon nanotube film.

### BRIEF DESCRIPTION OF THE FIGURES

The invention is best understood from the following detailed description when read in connection with the accompanying drawings. It is emphasized that, according to common practice, various features/elements of the drawings may not be drawn to scale. On the contrary, the dimensions of the various features/elements may be arbitrarily expanded or reduced for clarity. Moreover, in the drawings, common numerical references are used to represent like features/elements. Included in the drawings are the following figures:

FIG. 1(a) is an image illustrating an example of a single wall carbon nanotube (SWNT) sheet;

FIG. 1(b) is a Scanning Electron Microscopy (SEM) image of an SWNT sheet depicting highly entangled SWNT bundles;

FIG. 2(a) is an illustration of an exemplary actuator used in a cantilever system according to an embodiment of the present invention;

FIG. 2(b) is graph depicting the actuation response of the cantilever shown in FIG. 2(a) when light is switched between “on” and “off” settings according to an embodiment of the present invention;

FIG. 3(a) is an illustration of an experiment for strain characterization of an exemplary bimorph actuator used in an actuation system according to an embodiment of the present invention;

FIG. 3(b) is a graph illustrating a strain of the exemplary actuator shown in FIG. 3(a) under different white light intensities as a function of time according to an embodiment of the present invention;

FIG. 3(c) is a graph illustrating the strain response as a function of white light intensity according to an embodiment of the present invention;

FIGS. 4(a) and 4(b) are graphs illustrating the strain characteristics of the exemplary bimorph actuator shown in FIG. 3(a) as a function of laser intensity, where lasers are used as light sources;

FIGS. 5(a) and 5(b) are graphs illustrating the strain response of the exemplary actuator shown in FIG. 3(a) as a function of different wavelengths or photon energies, respectively, under a same laser power intensity;

FIGS. 6(a) and 6(b) are images illustrating a further exemplary cantilever system used as a gripping device and actuated by exposure to light according to an embodiment of the present invention, the gripping device depicted in an open position in FIG. 6(a) and in a closed position in FIG. 6(b);

FIGS. 6(c), 6(d), 6(e), 6(f), 6(g), 6(h), 6(i) and 6(j) are images illustrating a further exemplary cantilever manipulating an aluminum oxide particle of 0.3 grams according to an embodiment of the present invention;

FIGS. 7(a), 7(b), 7(c), 7(d), 7(e), 7(f), 7(g) and 7(h) are images illustrating an exemplary method of transferring a carbon nanotube film (CNF) to a substrate and patterning of the CNF by plasma etching according to an embodiment of the present invention;

FIGS. 8(a), 8(b), 8(c) and 8(d) are images illustrating a semi transparent CNF on a silicon wafer and CNF lines patterned according to the exemplary method shown in FIGS. 7(a)-7(h);

FIGS. 9(a) and 9(b) are images illustrating SEM images of exemplary released CNF/SU8 actuators at different levels of magnification according to an embodiment of the present invention; and

FIG. 10 is a graph with an image overlayed illustrating the displacement of the exemplary CNF/SU8 actuator shown in FIGS. 9(a) and 9(b) as a function of laser intensity.

### DETAILED DESCRIPTION OF THE INVENTION

As a general overview of exemplary embodiments, aspects of the present invention provide an actuator capable of converting optical energy into mechanical energy. An exemplary actuator includes a carbon nanotube sheet and at least one actuation material in communication with the carbon nanotube sheet. The carbon nanotube sheet and optionally the actuation materials expand when exposed to light, thus, providing mechanical actuation.

According to another embodiment, the present invention provides a method of preparing a carbon nanotube actuator device. The exemplary method may form an actuator device by forming a carbon nanotube film on a substrate, forming a photoresist layer on the carbon nanotube film to expose portions of the carbon nanotube film. Etching is then performed on the exposed portions of the carbon nanotube film to form the actuator from the remaining carbon nanotube film. The exemplary method may also include releasing the actuator device from the substrate. According to aspects of the present invention, a simple yet versatile subtractive patterning technique may thus be provided to form uniform thin nanotube films of a desired thickness.

The term “optical energy” as used herein, unless otherwise indicated, refers to light energy incident on the actuator. Optical energy is typically measured in Watts.

The term “mechanical energy” as used herein, unless otherwise indicated, refers to physical movement or strain of the actuator.

The term “optical absorption coefficient” as used herein, unless otherwise indicated, refers to the ability of a material to absorb light and convert optical energy into mechanical energy. The optical absorption coefficient is measured in terms of strain (change in length/original length×100) divided by the light intensity measured in Watts. Units for the optical absorption coefficient are (%/W).

The term “light source” as used herein, unless otherwise indicated, refers to laser, white light, ultraviolet light, infra-red light, X-rays and Terahertz light, and may include essentially any object that emits light.

Single wall carbon nanotubes (SWNTs) have excellent optical and thermal properties. For example, it has been determined that fluffy SWNT bundles can ignite under the flash light of an ordinary camera. Accordingly, SWNTs are excellent light absorbers, i.e., SWNTs readily absorb photon energy, and are capable of changing the optical energy into thermal energy. Other research has shown that individual SWNTs have a very high thermal conductivity along the axis of the carbon nanotube. For example, the room temperature thermal conductivity of isolated SWNTs is 6600 W/mK, which is much greater than the thermal conductivity of pure diamond, suggesting that SWNTs have excellent thermal conducting properties.

Because SWNTs exhibit excellent optical properties combined with excellent thermal conducting properties, there may be numerous applications of SWNTs in SWNT materials systems. For example, SWNTs may be used for the conversion of optical photon energy into thermal energy and then further into mechanical energy. Such a conversion may be used for an optical-mechanical transformation.

Polymers may be used as actuators that are responsive to light because of their strain and elastic energy density characteristics. In addition, polymers typically have good thermal expansion properties.

The inventors have determined that composites of polymers and SWNTs exhibit the advantages of both materials (i.e. polymers and SWNTs) individually. The polymer/SWNT composites also exhibit properties that are not existent in either of the materials separately. Exemplary polymer/SWNT composites, according to an embodiment of the present invention, provide actuation due to physical interlinks between elastic, optical, electrostatic and thermal effects in the carbon nanotubes. In particular, the polymer/SWNT composites can respond to light and exhibit higher stresses than natural muscles and higher strains than piezoelectric materials.

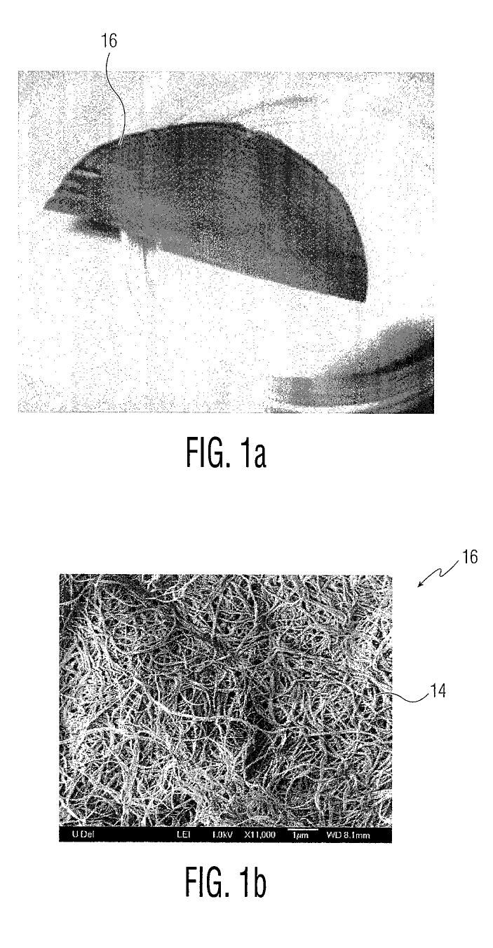

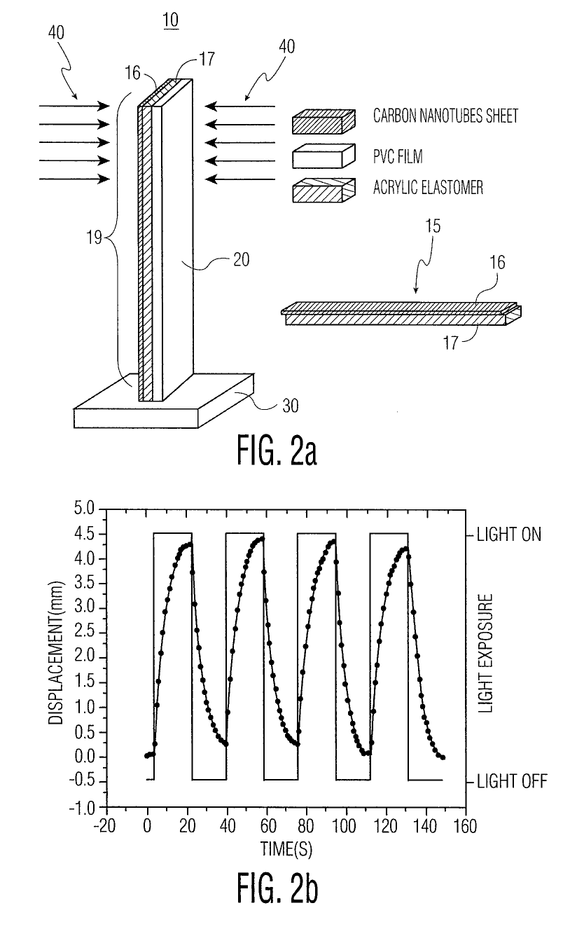

Referring generally to FIGS. 1(a), 1(b) and 2(a), in an exemplary embodiment, an actuation material 17 and sheet 16 of single or multi-wall carbon nanotubes 14 may be combined to form actuator 15 for the direct conversion of optical photon energy to mechanical energy. Actuator 15 may generally be referred to as a bimorph actuator. Actuator 15 may include a layer of single or multi-wall carbon nanotubes 14 as SWNT sheet 16 and an acrylic elastomer as the actuating material 17. The actuation material 17 may be in electronic, thermal or mechanical communication with the SWNT sheet 16.

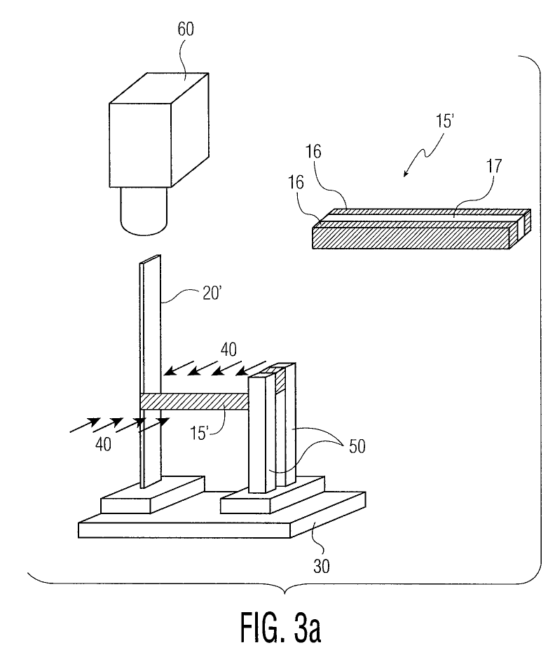

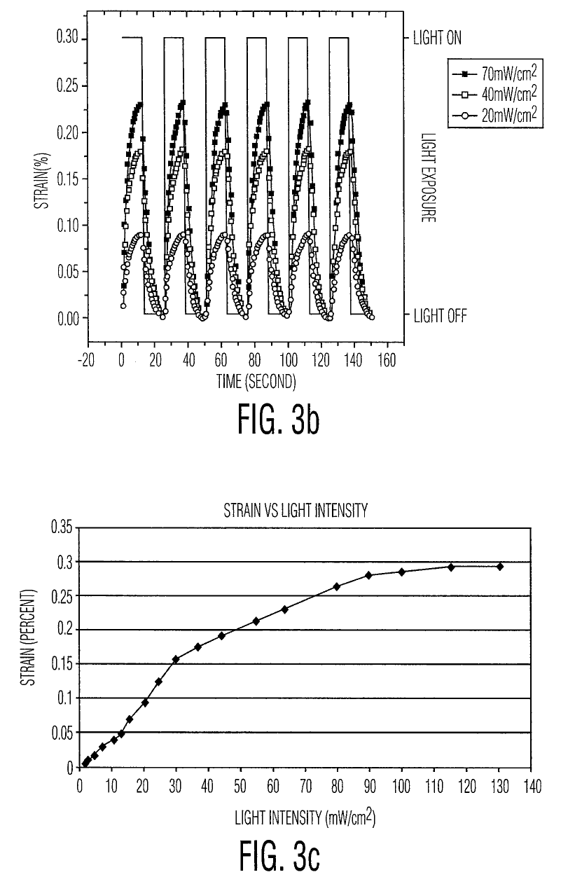

Referring generally to FIG. 3(a), in another exemplary embodiment, actuation material 17 and two sheets 16 of single or multi-wall carbon nanotubes 14 may be combined to form actuator 15′ for the direct conversion of optical photon energy to mechanical energy. Actuator 15′ includes an acrylic elastomer, as actuating material 17, provided between SWNT sheets 16.

Strain/expansion characteristics of exemplary actuators have been measured and examples are provided demonstrating the effectiveness of the actuator for manipulating small objects. Strain characteristics and examples of exemplary actuators are described below with respect to FIGS. 1-6 and Examples 1-5.

SWNT sheet 16 may have an optical absorption coefficient that is different from actuation material 17. In an exemplary embodiment, SWNT sheet 16 may include a first optical absorption coefficient that is greater than the optical absorption coefficient of the actuation material 17. In another embodiment, SWNT sheet 16 may include a first optical absorption coefficient that is lower than the optical absorption coefficient of the actuation material 17. In an exemplary embodiment, SWNT sheet 16 may include an optical absorption coefficient ranging from about 0.5% to about 3.75% per Watt and the actuation material 17 may have a second optical absorption coefficient ranging from about 0% per watt to about 0.1% per Watt.

In an exemplary embodiment, light that is incident on actuator 15 causes both SWNT sheet 16 and actuation material 17 to expand. Due to a difference in optical absorption coefficients of the SWNT sheet 16 and actuation material 17, expansion of SWNT sheet 16 and actuation material 17 may occur at different rates. Thus, an actuator 15 having SWNT sheet 16 and actuation material 17 may bend when light is incident on the actuator. If actuator 15 is combined with a polyvinyl chloride (PVC) film 20 (as illustrated in FIG. 2(a)) as a cantilever beam 19, the difference in optical absorption coefficients may cause cantilever beam 19 to bend, responsive to light. If actuator 15′ is positioned between an anchor 50 to which it is clamped and PVC film 20′ (as illustrated in FIG. 3(a)), the difference in optical absorption coefficients may cause actuator 15′ to expand primarily in a longitudinal direction, thus moving (i.e. bending) PVC film 20′.

According to an embodiment of the present invention, adjustment of actuator 15, 15′ (FIG. 2(a) and FIG. 3(a)) may be provided by adjusting an intensity of a light source and/or adjusting a wavelength of the light source. Because an expansion of actuator 15, 15′ is related to its strain response (i.e. the strain response of each of SWNT sheet 16 and actuation material 17), adjusting a light intensity or adjusting a wavelength may adjust an expansion, as well as a bending, of actuator 15,15′.

One advantage of bimorph actuator 15,15′, such as an acrylic elastomer/SWNT actuator, is that actuator 15,15′ may be easier to fabricate, as compared with other conventional designs. Another advantage of the present invention is that the actuator 15,15′ may be controlled remotely by exposing the actuator to light. Actuators 15,15′, thus, do not need to use complicated electrical connections commonly found in electrically activated actuators. In addition, actuators 15,15′ do not require large electric fields, unlike electroactive polymers (which typically use large electrical fields, and consequently high voltage). Furthermore, unlike electro-chemical actuators which typically utilize electrolytic systems that have limited use in dry environments, exemplary actuators 15,15′ do not need electrolytes and, thus, may work in dry environments as well as in liquid or aqueous environments.

The actuation material 17 may include acrylic elastomers, elastic polymers, dielectric elastomers, conducting polymers, electroactive polymers, oxide materials such as SiO₂, TiO₂, ZnO. In an exemplary embodiment, the actuator material 17 may include an acrylic elastomer or thin film oxide such as SiO₂. The actuator material 17 may also include any suitable photoresist materials, such as SU-8.

In an exemplary embodiment, a light source that provides light 40 (FIGS. 2(a) and 3(a)) such as a laser may be used to actuate the actuator 15,15′. Exemplary light sources include white light, ultraviolet light, infrared light, X-rays, Terahertz light, or femtosecond laser pulses.

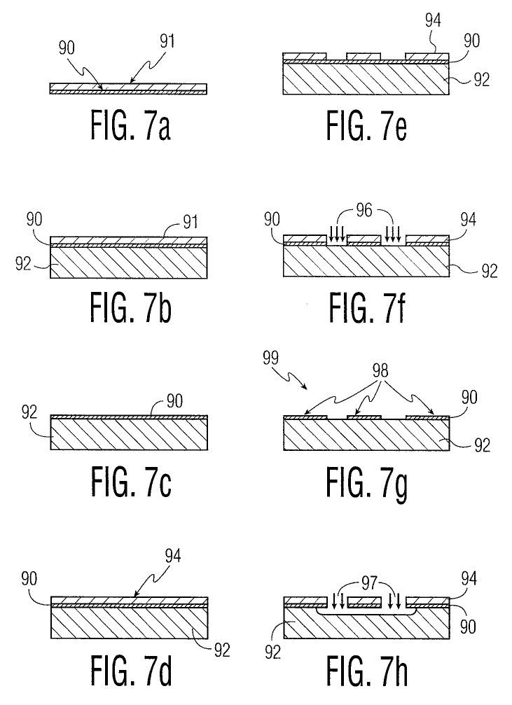

Another embodiment of the invention provides an exemplary patterning technique for an actuator (described further below with respect to FIGS. 7(a)-10). As shown in FIGS. 7(a)-7(h), uniform thin carbon nanotube films (CNF) 90 of desired thickness may first be formed by vacuum filtration, then transferred to a substrate 92, and followed by photolithography to define features of the actuator. Etching 96, such as O₂ plasma etching, may be subsequently used to selectively remove the exposed carbon nanotubes forming carbon nanotube film patterns. An exemplary patterning technique is described in detail below with respect to FIGS. 7-10 and Examples 6 and 7.

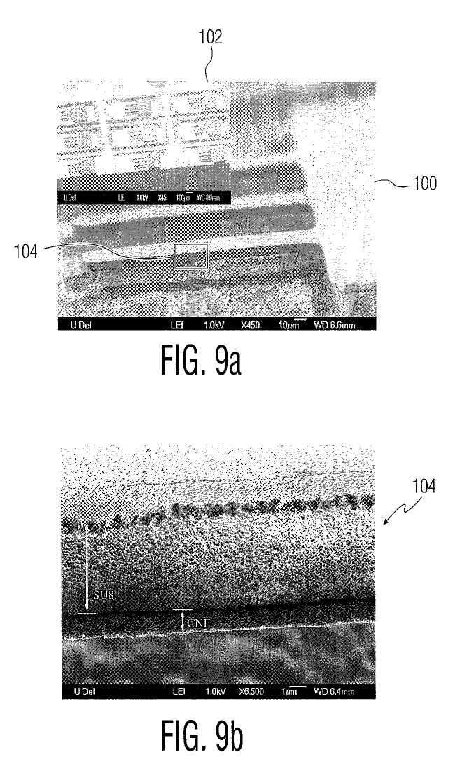

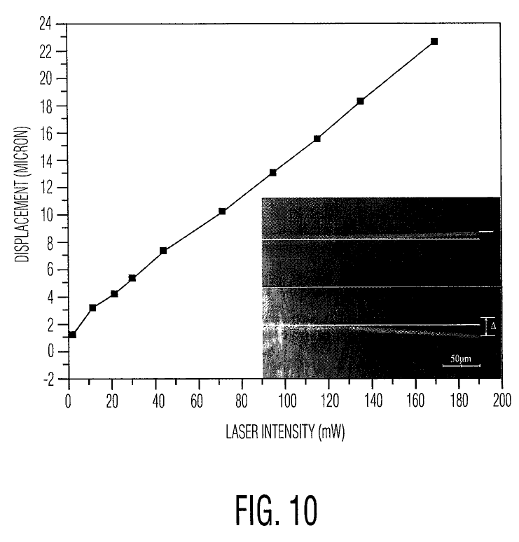

This method provides (1) a uniformity and a reproducibility of CNF within the patterns; (2) low processing temperatures compatible with polymeric substrates; (3) high feature resolutions even smaller than nanotube length due to the ability of plasma to etch the nanotubes precisely; (4) sharp pattern edges; and is (5) compatible with micro-electro-mechanical system (MEMS) fabrication technologies. As one of the applications of this patterning technique, a CNF/SU8 micro-optomechanical system (MOMS) has been demonstrated, having elastic light induced actuation. See FIGS. 9(a)-10.

O₂ plasma etching has been used to remove carbon based organic materials, such as photoresists from substrate surfaces. It typically forms volatile CO, CO₂ and H₂O which may be pumped out from the system during plasma etching. However, O₂ plasma etching of carbon nanotubes 14 (FIG. 1(b)) to define pre-patterned films has not been previously reported. According to an embodiment of the present invention, O₂ plasma may be used in an inductively coupled plasma (ICP) system to etch carbon nanotubes 14 in order to form CNF patterns. At an ICP power of about 200 W, a bias power of about 100 W, and an O₂ flow rate of about 50 sccm, an etch rate of CNF at about 4 nm/s was achieved, thus illustrating the fast etching of carbon nanotubes 14 in a strong O₂ plasma.

The exemplary methods of the present invention allow for the production of CNF lines as small as about μm with well defined shapes and sharp feature edges. It is contemplated that higher resolution patterns with feature sizes even smaller than nanotube lengths may be possible because of the ability of O₂ plasma to “cut” exposed carbon nanotubes to leave sharp pattern edges, as illustrated in the insert of FIG. 7(d). Electron beam lithography may reduce the size of CNF patterns, potentially achieving a feature size in the sub-100 nm regime for nanotube devices. Such an excellent pattern transfer may be due to a lack of stresses in the nanotube films after vacuum filtration. According to the present invention, well-defined high resolution CNF patterns may be achieved by a combination of nanotube film formation, transferring, photolithography and O₂ plasma etching processes. The exemplary process provides high resolution of CNF patterns and excellent reproducibility compared to conventional methods. The exemplary technique may be useful in a wide variety of applications, such as in MEMS, field emission displays, optical actuators and in biomedical nanotechnology for devices to study protein interactions.

The examples and preparations provided below further illustrate and exemplify the actuator devices of the present invention and the methods of actuation by converting optical energy into mechanical energy. It is to be understood that the scope of the present invention is not limited in any way by the scope of the following examples and preparations.

### EXAMPLE 1

Referring to FIGS. 1(a) and 1(b), SWNT sheets 16 were fabricated using methane based chemical vapor deposition. In particular, FIG. 1(a) is an image illustrating an example of a SWNT sheet 16 formed by vacuum filtration and FIG. 1(b) is a scanning electron microscopy (SEM) image of SWNT sheet 16 composed of highly entangled SWNT bundles 14 (i.e. nanotubes). The diameter of the illustrated nanotubes 14 range from 1.3 nm to 1.4 nm, measured using transmission electron microscopy (TEM) images of nanotubes 14. SWNTs 14 (80 mg) were dispersed in 100 ml of iso-propyl alcohol and agitated for 20 hours to disperse the nanotubes uniformly in solution, providing a final SWNT concentration of 0.8 mg/ml. The SWNT (20 ml) suspension was filtrated through a poly(tetrafluoroethylene) filter (47 mm in diameter) by vacuum filtration. The resulting SWNT sheet 16 on the filter was rinsed twice with iso-propyl alcohol and deionized water and then dried at 80° C. for 1 hour to further remove the remaining solution from SWNT sheet 16. After drying, SWNT sheet 16 was peeled off the filter. SWNT sheet 16 had a final thickness ranging from 30 μ,m to 40 μ,m and a bulk density of about 0.3 g/cm³, FIG. 1(a) shows the image of SWNT sheet 16 made by vacuum filtration. FIG. 1(b) discloses the scanning electron microscopy (SEM) image of SWNT sheet 16 and clearly illustrates the highly entangled SWNT bundles 14 having random tube orientations. SWNT sheets 16 of this type were used in making the exemplary actuators of the present invention without further optimization.

The illustrated actuator material 17 (shown in FIGS. 2(a) and 3(a)) used in the actuators disclosed in the examples of this application, is an acrylic elastomer purchased from 3M, and sold as 137DM-2. As discussed above, actuation material 17 is not limited to acrylic elastomers. Other suitable polymers for use as the actuation material 17 will be understood by one of skill in the art from the description herein. The 137DM-2 material is available as a precast adhesive tape having a 12.5 mm width and about a 70 thickness. A piece of acrylic elastomer film derived from the adhesive tape having dimensions of 30 mm×2 mm was attached to a piece of SWNT sheet 16 having the same dimensions by direct contact. The resulting exemplary bimorph (SWNT/acrylic elastomer) actuator 15 was then used to determine the photon induced actuation properties.

### EXAMPLE 2

Referring to FIGS. 2(a) and 2(b), an exemplary cantilever structure 10 was formed according to an exemplary embodiment. In particular, FIG. 2(a) illustrates a cantilever system including bimorph actuator 15 and PVC film 20 of 100 μm in thickness together forming exemplary cantilever beam 19, where cantilever beam 19 is vertically anchored on base 30 to form cantilever structure 10; and FIG. 2(b) is a graph depicting an actuation response of cantilever structure 10 with respect to time when light is switched between “on” and “off” settings.

Cantilever beam 19 was formed by attaching bimorph actuator 15 (described with respect to Example 1) to PVC film 20 having the same dimensions as bimorph actuator 15 but with a thickness of 100 μm. FIG. 2(a) shows cantilever beam 19 anchored on base 30, which may bend in a direction normal to the cantilever surface. Bimorph actuator 15 is shown in the lower right of this figure formed of acrylic elastomer 17 and SWNT sheet 16. A halogen lamp (not shown) is used as a white light source and light 40 is incident normal to the surface of cantilever structure 10. The light intensity was recorded on a Newport 1815-C intensity meter. A digital camera measurement system (not shown) was used to characterize the actuation. Because PVC film 20 and acrylic elastomer 17 are transparent, light was transmitted to both surfaces of the SWNT 16 with only negligible differences in the displacement measurement.

The actuation response of cantilever structure 10 under white light 40 exposure is shown in FIG. 2(b). White light 40 at an intensity of 60 mW/cm² was used to actuate cantilever structure 10 for four cycles. When light exposure was present, cantilever beam 19 was bent towards a side of PVC film 20, indicating that the length of bimorph actuator 15 increased in response to the light exposure. When the light source was turned off, bimorph actuator 15 contracted to its original size and cantilever beam 19 went back to its original position. The actuation response is repeatable from cycle to cycle with nearly the same displacement amplitude. When more cycles were tried with actuator 15, although the displacement amplitude remained the same, actuator 15 gradually showed a negative drift meaning that the cantilever beam 19 dropped back below the original position, illustrating a “negative” displacement opposite to the displacement direction under light exposure. A maximum displacement of 4.3 mm may be acquired from cantilever beam 19 having a length of 30 mm.

### EXAMPLE 3

Referring to FIGS. 3(a), 3(b) and 3(c), in order to characterize the strain of the actuator under light exposure, another exemplary actuation system was designed. In particular, FIG. 3(a) illustrates an experiment for strain characterization, where exemplary bimorph actuator 15′ is attached between vertical anchor 50 and PVC film 20′ of 100 μm in thickness, a stress from bimorph actuator 15′ bends PVC film 20′, and a displacement of a top of PVC film 20′ is recorded by digital camera system 60; FIG. 3(b) is a graph illustrating the strain of exemplary actuator 15′ under different white light intensity ranging from 70 mW/cm² (black), 40 mW/cm² (red), and 20 mW/cm² (green); and FIG. 3(c) is a graph illustrating the strain response as a function of white light intensity.

As shown in FIG. 3(a), bimorph actuator 15′ was double clamped between vertical anchor 50 and PVC film 20. PVC film 20 was 100 μm in thickness and was also fixed vertically on base 30. Actuator 15′ is the same as actuator 15 (FIG. 2(a)) except that actuator 15′ includes actuation material 17 sandwiched between SWNT sheets 16. A light source (not shown) was horizontally positioned and light 40 was incident normal to the surface of actuator 15′. A stress from bimorph actuator 15′ (30 mm×2 mm) under light exposure 40 bent PVC film 20′. The amount of displacement on the top of PVC film 20′ was recorded by digital camera system 60 and the displacement was calculated as the length of the bimorph actuator 15′ changed. All of the measurements were done at room temperature, i.e., approximately 37° C. A white halogen lamp with a tunable intensity was used as light source 40.

FIG. 3(b) shows six cycles of the strain response under different light intensities. The strain cycles are repeatable having nearly the same strain amplitude. In addition, all the strain values are positive, suggesting that exemplary bimorph actuator 15′ expands in the presence of light exposure and comes back to the inherent original strain free position when light source is deactivated. Acrylic elastomers (FIG. 2(a)) were used as the actuation material 17, due to the dielectric electroactive properties of these polymers. In an exemplary embodiment of the present invention, acrylic elastomers 17 may be used because of their strain and elastic energy density characteristics. In addition, acrylic elastomers 17 have good thermal expansion properties.

FIG. 3(b) shows the strain of actuator 15′ under different white light intensity of 70 mW/cm² (black), 40 mW/cm² (red) and 20 mW/cm² (green). It is evident that the more light intensity incident on actuator 15′, the greater the strain amplitude. FIG. 3(c) depicts this trend in the curve of strain versus incidence light intensity in the range of from 0 to 13 mW/cm². FIG. 3(c) illustrates that when the light intensity is relatively small, the strain increase is rapid. On the other hand, when light intensity is higher (80 mW/cm²), the strain response begins to levels off. The strain value, therefore, gradually comes to a saturation point of about 0.29% when the light intensity approaches 110 mW/cm². Accordingly, the more light intensity used between 0 and 110 mW/cm², the more photon energy is absorbed by SWNTs 14, and in turn the more thermal energy transferred to the actuation material 17 of the actuator. The effect is to raise the temperature of actuation materially, to a higher temperature where more strain is provided.

To illustrate the robustness of the actuation mechanism, the structure shown in FIG. 3(a) was placed into deionized water and the actuator 15′ was exposed to light 40 at 70 mW/cm². A strain value of 0.06% was acquired, which is about twenty-five percent (25%) of the value when the measurement is performed under dry conditions at room temperature. Without being bound to any particular theory, it is believed that the smaller strain in deionized water may be due to the light absorption of water which results in SWNTs 14 (FIG. 1(b)) of bimorph actuator 15′ receiving less light intensity. At the same time, however, it should be noted that thermal energy from nanotubes 14 will dissipate through water resulting in a lower temperature rise in the actuation material 17, producing an even lower strain response.

### EXAMPLE 4

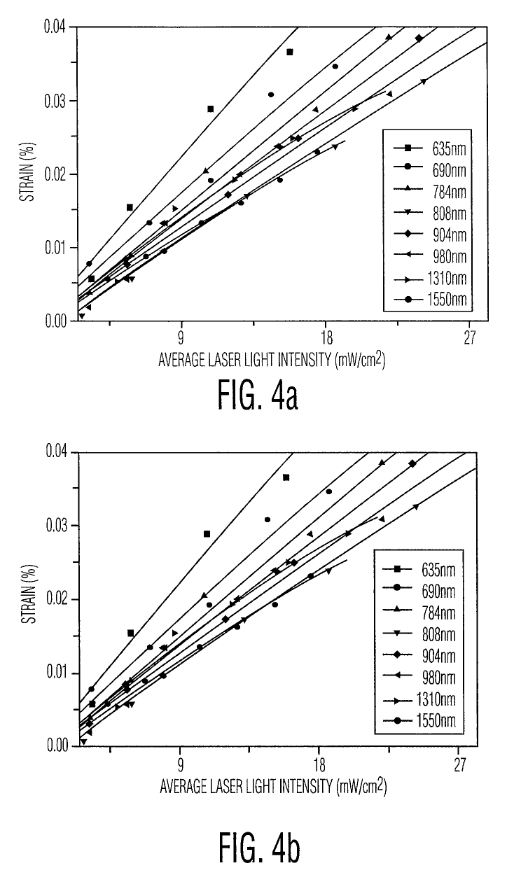

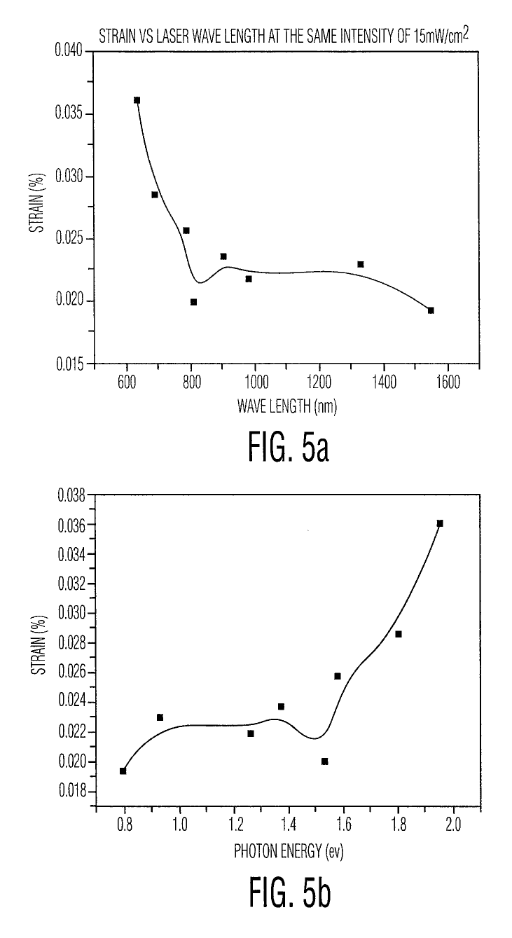

Examples 1 and 2 used a halogen lamp as the light source. The spectrum of the light source covers a broad range of the electromagnetic spectrum from the visible light region to the near infrared light region. A separate set of experiments have demonstrated the effect of particular segments of the electromagnetic spectrum on the strain response. Referring to FIGS. 4(a), 4(b), 5(a) and 5(c) these figures illustrate the strain characteristics of an exemplary bimorph actuator 15′ (FIG. 3(a)) when lasers are used as the light source. In particular, FIG. 4(a) is a graph of intensity illustrating the strain response using different lasers; FIG. 4(b) is a graph of intensity of a portion part of FIG. 4(a) in the light power range from 3 mW/cm² to 28 mW/cm², to illustrate the difference between the curves; FIG. 5(a) illustrates the strain response of different wavelengths under the same laser power intensity of 15 mW/cm²; and FIG. 5(b) illustrates the strain response of photon energies under the same laser power intensity of 15 mW/cm².

Mono wavelength lasers were used as light sources to actuate actuator 15′ shown in FIG. 3(a). Eight semiconductor lasers (wavelength: 635 nm, 690 nm, 784 nm, 808 nm, 904 nm, 980 nm, 1310 nm, 1550 nm) were used with the wavelength ranging from 635 nm to 1550 nm. The lasers were specifically selected to cover the visible light spectrum and the near infrared spectrum. The average light intensity shining on the actuator surface was tuned to range from 0 to 65 mW/cm² depending on the maximum output power of the lasers. FIG. 4 shows the strain characteristics of the bimorph actuator 15′ when different lasers are used as the light source. In FIG. 4(a) it is clear that for all the lasers, an increase in light intensity produces a greater strain response. This is similar to the trend observed when white light was used as the light source. Without being bound to any particular theory it is believed that the same reasoning applies to lasers as with white light actuated samples. The greater the light intensity, the more photon energy absorbed by SWNTs 14 (FIG. 1(b)). This translates into higher temperatures for the actuation material 17, which in turn results in a higher strain response.

The data points in FIG. 4(a) are the experimental data whereas the lines are the polynomial fittings corresponding to the data. All the curves appear to be linear when the laser intensity is smaller than 40 mW/cm². However, when the laser intensity increases above 40 mW/cm², the increase in strain response is not as notable (see the curve corresponding to 690 nm, 808 nm, 980 nm lasers). In other words, only traces of strain response saturation are observed. This trait is more apparent in the case of white light FIG. 3(c). Without being bound to any particular theory, it is believed that the reason the saturation effect is not as pronounced with laser light intensity is that the intensity of laser light is not large enough for actuator 15′ to get to the saturation point, whereas, when white light is used, the light intensity is high enough to reach saturation levels.

FIG. 4(b) is the magnified part of FIG. 4 (a) in the light power range between 3 mW/cm² to 28 mW/cm². FIG. 4(b) clearly illustrates the difference between the curves. When the light intensity is the same for all of the lasers, it is found that the strain response is a function of wavelength or photon energy.

FIG. 5 shows the strain response at different wavelengths (FIG. 5(a)) or photon energy (FIG. 5 (b)) under the same laser power intensity of 15 mW/cm². The lines in FIG. 5 are the polynomial fittings of experimental data. FIG. 5 demonstrates that as the wavelength of the lasers increase, or as the photon energy decreases, the strain response roughly trends lower.

In the spectral range of visible light and near infrared light region, there are mainly three broad absorption bands for SWNTs 14 (FIG. 1(b)) and peak energies depends on the diameters of nanotubes 14. Without being bound to any particular theory, it is believed that the first and second peaks in the lower photon energy region are due to valence band-conduction transitions from semiconducting SWNTs, whereas the third peak at the higher photon energy region is due to metallic SWNTs. For nanotubes 14 with diameters of about 1.35 nm, used here in the examples, the second absorption peak should appear at about 1.3 eV photon energy. As shown in FIG. 5, the strain response curves have a broad peak at about 1.37 eV.

This strain peak is due to the second absorption peak in the SWNTs absorption spectrum. The strain response peaks corresponding to the first and third absorption peaks in a SWNT absorption spectrum were not observed because the laser energies used cover narrow spectrum ranges. However, one can conclude from the rough agreement between the observed strain response peak and the predicted second SWNT absorption peak, that optical absorption of SWNTs is the origin of the strain response effect. In FIG. 5(b), it is also observed that when the photon energy increases from 0.8 eV to 1.94 eV, the strain response values also increase from 0.192% to 0.365%. It is therefore apparent that one can choose actuation wavelengths or light intensity to control the strain response values.

### EXAMPLE 5

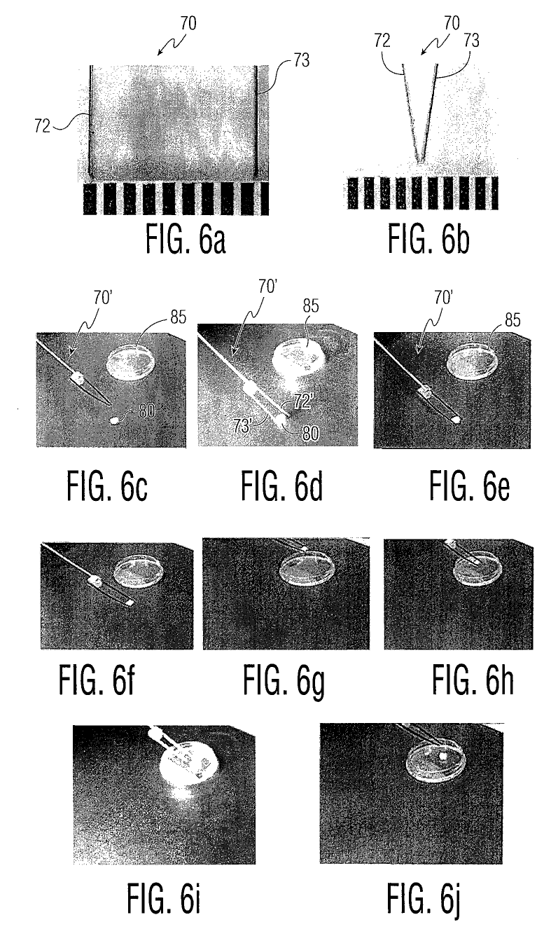

Referring to FIGS. 6(a)-6(j), a simple demonstration of the application of an exemplary actuator of the present invention is provided. In particular, FIGS. 6(a) and 6(b) are images illustrating two cantilever beams 19 formed as gripping device 70 being actuated by exposure to light; and FIGS. 6(c)-6(j) are images illustrating exemplary gripping device 70′ manipulating an aluminum oxide particle of 0.3 grams into Petri dish 85.

Gripping device 70 was made from exemplary bimorph actuators 15 (FIG. 2(a)) and used for manipulating small objects. In FIGS. 6(a) and 6(b), the cantilever structure (i.e. using beams 72,73) has a size of 30 mm in length and 2 mm in width (not shown). The detailed structure of beams 72, 73 is the same as shown in FIG. 2(a). Two beams 72, 73, are use to form gripping device 70. PVC film 20 sides (FIG. 2(a)) are facing each other at the “inner” surfaces of the beams 72, 73, whereas actuator 15 are at the “outer” surfaces of beams 72, 73. When light shines on gripper 70, the two beams 72, 73, which were originally separated by 8 mm in distance, bend and clamp together. FIGS. 6(c)-6(j) show gripping device 70′ that is similar in structure to gripping device 70 in FIG. 6 (a), but with the actuator 15 sides facing one another at the “inner” surfaces of the beams 72′, 73′. Gripping device 70′, shown in FIGS. 6(c)-6(j), was used to move a piece of aluminum oxide particle 80 (4 mm in length, 2 mm in diameter and 0.3 gram in weight) into Petri dish 85. Two beams 72′, 73′ are positioned so that they clamp toward one another without light exposure. When gripping device 70′ is exposed to light, beams 72′, 73′ open to grip particle 80. The light is then turned off, so that particle 80 is clamped between beams 72′, 73′. After particle 80 is moved to a position above Petri dish 85, gripping device 70′ was again opened by light exposure to release particle 80.

This technology is shown to have great potentials in many applications, for example, robotics, remote controlling and optical-mechanical system. An exemplary actuator, according to an embodiment of the present invention is easy to fabricate. The exemplary actuator may be used in integrated optical device technology, in which the fabrication processes of light sources such as semiconductor lasers and light emitting diodes are well developed. The exemplary actuator may also overcome basic limitations for other types of actuators such as use of high voltage or an electrolyte working environment. As discussed above, an exemplary actuator may operate in dry ambient conditions as well as in a liquid environment.

### EXAMPLE 6

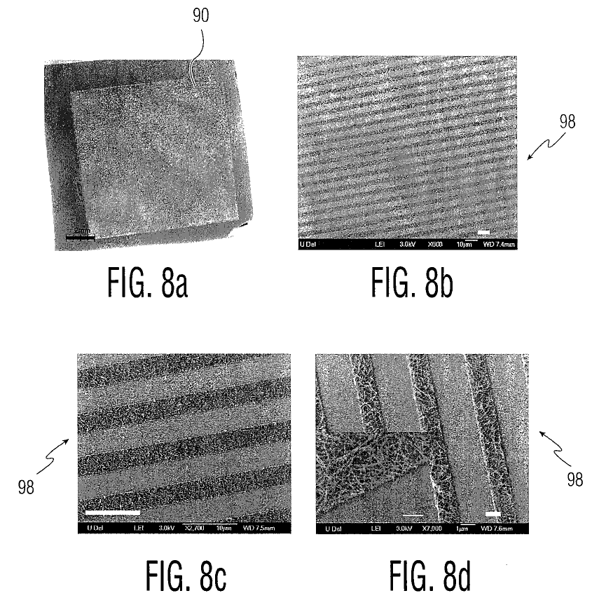

Referring to FIGS. 7(a)-7(h), 8(a)-8(d), images are shown illustrating an exemplary sequence of transferring CNF 90 to substrate 92 and subsequent patterning by O₂ plasma etching 96, according to an embodiment of the present invention. In particular, FIG. 7(a) illustrates CNF 90 on a mixed cellulose ester (MCE) filter 91 after vacuum filtration; FIG. 7(b) illustrates CNF 90 with MCE filter 91 being transferred onto silicon substrate 92; FIG. 7(c) illustrates dissolving of MCE filter 91; FIG. 7(d) illustrates application of spin coating photoresist 94; FIG. 7 (e) illustrates performing photolithography to the resulting structure of FIG. 7(d); FIG. 7 (f) illustrates performing O₂ plasma etching 96 of CNF 90; FIG. 7 (g) illustrates actuator 99 after removal of the masked photoresist 94 and CNF patterns 98; FIG. 7 (h) illustrates that, in case of CNF/SU8 actuator, XeF₂ etching 97 was used to release the actuator structure; FIG. 8(a) illustrates a semi transparent CNF 90 of about 130 nm covered on silicon wafer 92; FIG. 8(b) illustrates a SEM image of CNF lines (i.e. CNF patterns 98) about 4 μm width fabricated by O₂ plasma etching 96; FIG. 8(c) illustrates a higher magnification image of the CNF patterns 98 shown in FIG. 8(b); and FIG. 8(d) illustrates clear patterns 98 of about 1.5 μm CNF lines with about 2 μm spacing. The insert on FIG. 8(d) illustrates a sharp pattern edge formed by nanotube cutting in O₂ plasma, where the scale bars represent: FIG. 8(a) 2 mm, FIGS. 8(b) and 8(c) 10 μm, FIG. 8(d) 1 μm, and insert in FIG. 8(d) 500 nm.

Commercially obtained single wall carbon nanotubes were dispersed in iso-propyl alcohol to −0.1 mg/ml by ultra-sonication, and was vacuum filtrated through 47 mm diameter mixed cellulose ester (MCE) filter 91 to produce CNFs 90. A simple procedure was employed to transfer CNF 90 onto a silicon substrate 92, as shown in FIG. 7 sequence (a) to (c). Briefly, the wet CNF 90 on top of MCE filter 91 was transferred onto silicon substrate 92 by compressive loading. Upon CNF drying and subsequent annealing on a 75° C. hotplate for 20 minutes, CNF 90 was adhered onto substrate 92 with enough adhesion strength for further processing. MCE filter 91 was then dissolved in multi baths of acetone, leaving clean uniform wrinkleless CNF 90 on substrate 92 after drying.

FIG. 8(a) shows uniform CNF 90 of about 1 cm×1 cm×230 nm transferred onto silicon wafer 92. The thickness of CNF 90 was well controlled by the amount of carbon nanotube solution of known concentration during vacuum filtration. Several CNFs 90 of thickness about 40 nm, 130 nm, 230 nm, 460 nm and 780 nm were fabricated with high film uniformity by a vacuum filtration process. Because the film thickness was smaller than 230 nm, CNF 90 showed a high degree of transparency visible to the naked eye.

Photolithography was then used to define CNF patterns 98 on substrate 92. Several commercial photoresists 94 of both positive and negative tones, including AZ5214E, NR7-1500, AZ4620 and SU8 (MicroChem. Corp., Newton, Mass. 02464) have been tested and all formed excellent features when formed on CNF 90. This indicates that randomly oriented nanotubes packed into thin films do not substantially affect the lithographic process. The excellent compatibility of CNF 90 with photolithography allows for defining precise and high resolution features onto CNF 90 through lithography, according to a thickness of photoresist 94. Because O₂ plasma etching 96 strips photoresist 94, an etch-mask out of photoresist 94 is desirably thick enough to sustain continuous O₂ plasma etching 96. For CNF 90 with a thickness smaller than 460 nm, about 1.5 μm photoresist 94 (AZ5214E) was used as the etch-mask. Commercial thick film photoresists 94, such as AZ4620, was also used to pattern thick etch-masks up to tens of microns for etching thicker CNFs 90. FIGS. 7(d) and 7(e) in illustrate the photolithography processes.

After etching, mild acetone rinsing served to dissolve the etch-mask such as to leave clean CNF patterns 98. The etching process and subsequent etch-mask removal are schematically shown in FIGS. 7(f)-7(g). Well-defined CNF stripe lines (i.e. CNF patterns 98) of about 4 μm in width and 130 nm thick were fabricated with the unwanted CNF removed, as shown in FIGS. 7(b) and 7(c). Clear patterns show the effectiveness of CNF patterning through O_{Z} plasma etching 96. In FIG. 8(d), CNF lines as small as about 1.5 μm were also routinely produced on 130 nm thick CNF.

### EXAMPLE 7

Referring to FIGS. 9(a), 9(b) and 10, exemplary nanotube-based MOMS actuators 100 were fabricated, according to an exemplary embodiment of the present invention, to realize optical actuation. In particular, FIG. 9(a) illustrates a SEM image of released CNF/SU8 actuators 100, where the insert illustrates a SEM image of 3×3×3 actuator array 102; FIG. 9(b) illustrates a SEM image of the squared region 104 shown in FIG. 9(a) showing a bilayer cross-section of exemplary actuator 100; and FIG. 10 illustrates a displacement of exemplary CNF/SU8 actuator 100 as a function of laser intensity, where the insert in FIG. 10 illustrates a cross-sectional view of actuation under laser light stimulus and straight lines were drawn for eye guidance.

SU8 photoresist 94 (FIG. 7(d)), which has excellent mechanical properties, a large thermal expansion coefficient and biocompatibility, was used in lithography to define CNF patterns 98 (FIG. 7(g)) and act as an etch-mask in plasma etching. CNF/SU8 composite structure 100 (FIG. 9(a)) was produced, according to the exemplary method as described in Example 6 above (FIGS. 7(a)-7(g)). After etching, the CNF/SU8 composite structure was released from the silicon substrate by isotropic silicon etching 97 in a pulse mode XeF₂ dry etching system, as illustrated in FIG. 7 sequence (h). A blind cut of the substrate after actuator 100 (illustrated as 99 in FIG. 7(g)) release also provided a better view of actuation from the exemplary cantilever actuator.

Arrays 102 of exemplary actuators are shown in the insert of FIG. 9(a). The magnified image of about 30 μm (width)×300 μm (length)×7 μm (thickness) cantilevers (i.e. actuators 100) after releasing are also shown in FIG. 9(a). FIG. 9(b) shows the cross-sectional area of the cantilever in squared region 104, with the SU8 (i.e. photoresist 94) and CNF layers 90 clearly observed. This indicates that a high quality CNF layer 90 may be formed from plasma etching 96 and may be introduced into micro-devices to exhibit multiple functionalities. When 808 nm laser light collimated into about a 0.5 mm×2 mm spot was pointed to a cantilever of actuators 100, it actuated the cantilever with bending toward the side of CNF 90.

FIG. 10 depicts the cantilever shown in FIG. 9(a) bending as a function of laser power. A nearly linear response was shown with a maximum displacement of about 23 μm under 170 mW illumination in air. The insert in FIG. 10 clearly shows the bending of the exemplary actuator under light exposure. The performance of the exemplary MOMS actuator 100 was at least comparable with that of electrically actuated SU8 actuators. The actuation arises due to the physical interlinks between elastic, electrostatic, optical and thermal effects in nanotubes. Most MEMS based electrostatic actuators use a large voltage for actuation. MOMS actuator 100 exhibited eye observable actuation up to 15 Hz. It is expected that further refining of device structure and physical properties of nanotubes can greatly improve its actuation performance and also impart wavelength selectivity to these optical actuators.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of actuation comprising:
activating a light source to transmit light;
exposing an actuator to the transmitted light, the actuator including a carbon nanotube sheet and an actuation material in communication with the carbon nanotube sheet, the carbon nanotube sheet having a first optical absorption coefficient and the actuation material having a second optical absorption coefficient different from the first optical absorption coefficient, the actuator expanding due to the exposure to the transmitted light to mechanically actuate the actuator.

2. The method according to claim 1, further including deactivating the light source to reverse the mechanical actuation.

3. The method of claim 1, wherein the actuation material is selected from the group consisting of acrylic elastomers, elastic polymers, dielectric elastomers, conducting polymers, electroactive polymers, thin film oxides and a photoresist.

4. The method of claim 1, further comprising adjusting an intensity of the light source to adjust an amount of the mechanical actuation of the exposed actuator.

5. The method of claim 1, further comprising adjusting a wavelength of light from the light source to adjust an amount of the mechanical actuation of the exposed actuator.

6. The method of claim 1, wherein the light source is selected from the group consisting of a laser, white light, ultraviolet light, and infrared light.

7. The method of claim 1, wherein the actuator bends during the exposing step.

8. The method of claim 7, wherein the actuator bends due to the difference between the first optical absorption coefficient and the second optical absorption coefficient.

9. An actuator comprising:
a carbon nanotube sheet having a first optical absorption coefficient; and
an actuation material in communication with the carbon nanotube sheet having a second optical absorption coefficient different from the first optical absorption coefficient;
wherein the actuator expands when exposed to light to mechanically actuate the actuator.

10. The actuator of claim 9, wherein the actuation material is in electronic, thermal or mechanical communication with the carbon nanotube sheet.

11. The actuator of claim 9, wherein the carbon nanotube sheet is formed from single wall carbon nanotubes.

12. The actuator of claim 9, wherein the actuation material is selected from the group consisting of acrylic elastomers, elastic polymers, dielectric elastomers, conducting polymers, electroactive polymers, thin film oxides and a photoresist.

13. The actuator of claim 9, wherein the carbon nanotube sheet and the actuation material each expand at a different rate due to the difference between the first optical absorption coefficient and the second optical absorption coefficient to cause the actuator to bend.

14. The actuator of claim 9, wherein the first optical coefficient is greater than said second optical absorption coefficient.

15. The actuator of claim 9, wherein the first optical absorption coefficient is lower than the second optical absorption coefficient.

16. The actuator of claim 9, wherein the first optical absorption coefficient is from about 0.5 to about 3.75%/W.

17. The actuator of claim 16, wherein the second optical absorption coefficient is from about 0 to about 0.1%/W.

18. The actuator of claim 9, wherein the carbon nanotube sheet has a first surface and a second surface opposite the first surface, the actuation material is adjacent the first surface, and the actuation material is transparent such that the first surface and the second surface of the carbon nanotube film are exposed to the light.

19. The actuator of claim 9, including a further carbon nanotube sheet adjacent the actuation material such that the actuation material is positioned between the carbon nanotube sheet and the further carbon nanotube sheet.

20. An actuator system comprising:
a base;
an anchor extending from the base;
a polyvinyl chloride (PVC) film extending from the base; and
the actuator according to claim 19 extending between the anchor and the PVC film, the actuator spaced from the base.

21. A cantilever actuator comprising:
a base; and
a cantilever beam including the actuator according to claim 9 and a polyvinyl chloride (PVC) film provided on the actuator, the cantilever beam extending from the base,
wherein the mechanical activation by the actuator bends the cantilever beam.

22. The cantilever system of claim 21, wherein:
a further cantilever beam extending from the base is positioned to form a gripping device capable of gripping an object responsive to the actuation by the light.

23. A method of preparing a carbon nanotube actuator device comprising the steps of:
forming a carbon nanotube film on a substrate;
forming a photoresist layer on the carbon nanotube film that exposes portions of the carbon nanotube film; and
etching the exposed portions of the carbon nanotube film to form the actuator device from the remaining carbon nanotube film.

24. The method of claim 23, further comprising releasing the actuator device from the substrate.

25. The method of claim 23, wherein forming the carbon nanotube film on the substrate includes:
forming the carbon nanotube film by a vacuum filtration process; and
transferring the formed carbon nanotube film onto the substrate.

26. The method of claim 23, wherein the carbon nanotube film includes carbon nanotubes formed from single wall carbon nanotubes.

27. The method of claim 23, wherein the step of etching the portions of the carbon nanotube film includes O₂ plasma etching.
